(19) United States
(12) Patent Application Publication
(10) Pub. No.: US 2021/0299915 A1
(43) Pub. Date: Sep. 30, 2021

(54) METHOD FOR MANUFACTURING FRESNEL LENS MOLD, MACHINING APPARATUS, AND CUTTING TOOL

(71) Applicant: National University Corporation Tokai National Higher Education and Research System, Aichi-ken (JP)

(72) Inventor: Eiji SHAMOTO, Nagoya-shi Aichi (JP)

(21) Appl. No.: 17/185,234

(22) Filed: Feb. 25, 2021

Related U.S. Application Data
(63) Continuation of application No. PCT/JP2020/013682, filed on Mar. 26, 2020.

(51) Int. Cl. B29C 33/38; B23B 27/14

(52) U.S. Cl. CPC B29C 33/3842; B23B 2200/242; B23B 27/145

(57) ABSTRACT

Provided is a method for manufacturing a Fresnel lens mold by performing cutting process on a workpiece with a cutting tool, the Fresnel lens mold having a lens surface and an upright surface alternately arranged. The cutting tool has a first cutting edge having an arc shape with a radius r and a second cutting edge continuous to the first cutting edge. A machining apparatus repeatedly performs a first process of forming, with the first cutting edge, a lens mold surface serving as a mold of a lens surface of a Fresnel lens, and a second process of forming, with the second cutting edge, an upright mold surface serving as a mold of an upright surface of the Fresnel lens to manufacture the Fresnel lens mold.

### CROSS-REFERENCE TO RELATED APPLICATIONS

This application is based upon and claims the benefit of priority from the International Application No. PCT/JP2020/013682, filed on Mar. 26, 2020, the entire contents of which are incorporated herein by reference.

### BACKGROUND

### 1. Field of the Disclosure

The present disclosure relates to a technique for manufacturing a Fresnel lens mold.

### 2. Description of the Related Art

FIG. 1 shows a cross section of a Fresnel lens. A Fresnel lens 20 has a surface shape having a lens surface 21 and an upright surface (also referred to as a “rise surface”) 22 concentrically and alternately arranged. The Fresnel lens 20 is mass-produced by injection molding of a plastic resin material such as acrylic or polycarbonate using a mold. Since the mold of the Fresnel lens 20 has a shape symmetrical about a rotation axis, the mold is often manufactured by turning process.

FIG. 2 is a diagram for describing a known finishing process on a Fresnel lens mold. A Fresnel lens mold 30 has a surface shape having a lens mold surface 31 serving as a mold of the lens surface 21 of the Fresnel lens 20 and an upright mold surface 32 serving as a mold of the upright surface 22 of the Fresnel lens 20 concentrically and alternately arranged. During the known finishing process on the mold 30, a nose cutting edge 26, having a minute arc shape (nose radius r), located at a tip of a cutting tool 25 is fed, relative to a rotating workpiece, on a path where a nose center 27 is separated from a target cross-sectional shape by r to alternately finish the lens mold surface 31 and the upright mold surface 32 (see, for example, JP 2011-121146 A). A long dashed short dashed line shown in FIG. 2 represents the feed path of the nose center 27.

This finishing process causes an arc shape having the radius r of the nose cutting edge 26 to remain at a corner 33 that is a boundary between the lens mold surface 31 and the upright mold surface 32.

Since a region of the lens surface 21 to which the roundness of the corner 33 is transferred does not act as a lens, it is preferable that the arc radius r of the corner 33 be as small as possible.

It is known that a finished surface roughness Rth of the lens mold surface 31 serving as a mold of the Fresnel lens surface can be theoretically estimated by the following equation (1).

$${R}_{th} \approx \frac{{f}^{2}}{8 r} \qquad ( 1 )$$

where “r” represents the nose radius of the nose cutting edge 26, and “f” represents a feed amount by which the cutting tool 25 is fed on a tool path (“nose center path” shown in FIG. 2) per revolution of a workpiece. With reference to Equation (1), it is shown that an increase in the nose radius r and/or a reduction in the feed amount f makes it possible to reduce the finished surface roughness Rth and increase lens performance.

However, as described above, since the nose radius r corresponds to the arc radius of the corner 33, the nose radius r cannot be increased, and the useless region of the lens surface 21 of the Fresnel lens 20 cannot be reduced accordingly. Further, when the feed amount f is reduced, the finished surface roughness Rth can be reduced, whereas machining efficiency is lowered, which is not preferable from the viewpoint of cost. Note that when the feed amount f is reduced, a cutting distance of the cutting tool 25 becomes longer, which causes the tool to wear quickly.

For example, when the nose radius r is equal to 5 μm, setting the feed amount f per revolution to 1 μm allows the finished surface roughness Rth to be equivalent of a mirror surface level (about 0.025 μm). However, high machining efficiency cannot be achieved with the feed amount f per revolution set to 1 μm.

### SUMMARY

The present disclosure has been made in view of such circumstances, and it is therefore an object of the present disclosure to provide a technique for manufacturing a Fresnel lens mold with high machining efficiency.

In order to solve the above-described problems, one aspect of the present disclosure relates to a method for manufacturing a Fresnel lens mold by performing cutting process on a workpiece with a cutting tool, the Fresnel lens mold having a lens surface and an upright surface alternately arranged. The cutting tool thus used has a first cutting edge having an arc shape with a radius r1 and a second cutting edge continuous to the first cutting edge. The method for manufacturing a mold includes a first process of forming, with the first cutting edge, a lens mold surface serving as a mold of a lens surface of a Fresnel lens, and a second process of forming, with the second cutting edge, an upright mold surface serving as a mold of an upright surface of the Fresnel lens, and the first process and the second process are repeatedly performed to manufacture the Fresnel lens mold.

Another aspect of the present disclosure relates to a machining apparatus structured to perform cutting process on a workpiece with a cutting tool to manufacture a Fresnel lens mold having a lens surface and an upright surface alternately arranged. The cutting tool thus used has a first cutting edge having an arc shape with a radius r1 and a second cutting edge continuous to the first cutting edge. The machining apparatus includes a motion mechanism structured to move the cutting tool relative to the workpiece, and a control device structured to control operation of the motion mechanism to repeatedly perform process of forming a lens mold surface serving as a mold of a lens surface of a Fresnel lens with the first cutting edge and process of forming an upright mold surface serving as a mold of an upright surface of the Fresnel lens with the second cutting edge.

Yet another aspect of the present disclosure relates to a cutting tool for use in manufacturing a Fresnel lens mold. The cutting tool includes a first cutting edge having an arc shape with a radius r1, the first cutting edge being structured to finish a lens mold surface serving as a mold of a lens surface of a Fresnel lens, and a second cutting edge continuous to the first cutting edge, the second cutting edge being structured to finish an upright mold surface serving as a mold of an upright surface of the Fresnel lens.

Note that any combination of the above-described components, or an entity that results from replacing expressions of the present disclosure among a method, an apparatus, a system, and the like is also valid as an embodiment of the present disclosure.

### BRIEF DESCRIPTION OF THE DRAWINGS

FIG. 1 is a diagram showing a cross section of a Fresnel lens;

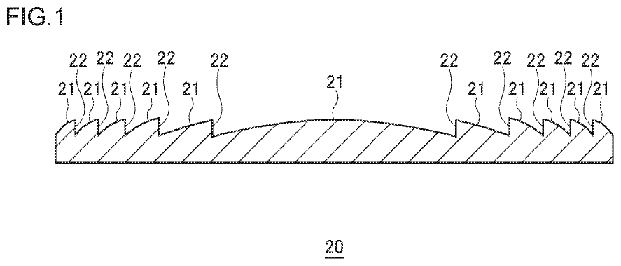

FIG. 2 is a diagram for describing a known finishing process;

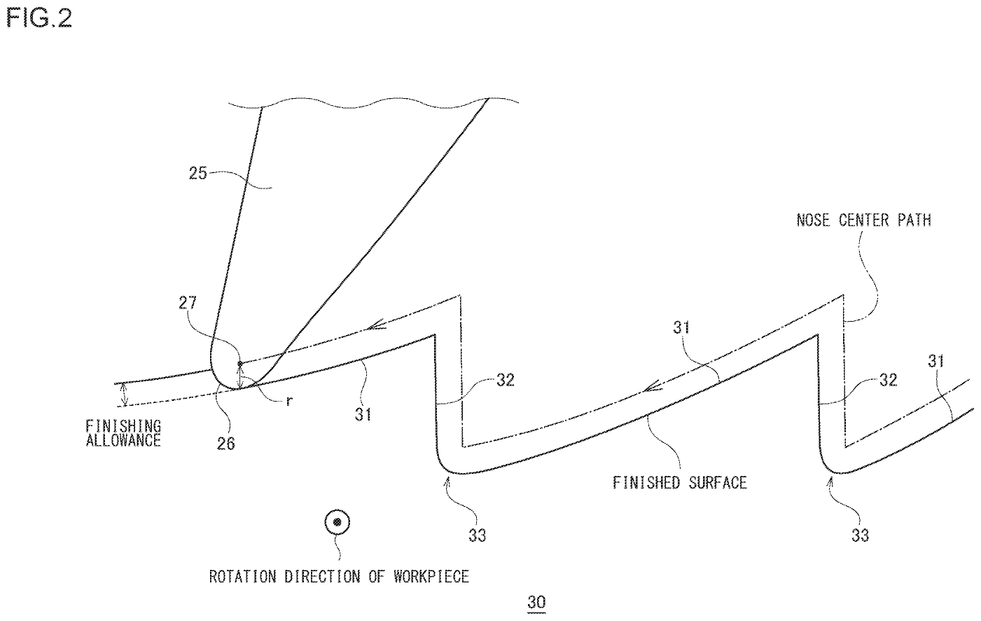

FIG. 3 is a diagram showing a schematic structure of a machining apparatus according to an embodiment;

FIG. 4 is a diagram showing an outline of a cutting edge shape of a cutting tool according to a first example;

FIG. 5 is a diagram showing a procedure of forming a Fresnel lens mold;

FIG. 6 is a diagram for describing a finishing process according to the first example;

FIG. 7 is a diagram showing a state of a cutting edge of a cutting tool 5 located at a corner; and

FIG. 8 is a diagram for describing a finishing process according to a second example.

### DETAILED DESCRIPTION

The disclosure will now be described by reference to the preferred embodiments. This does not intend to limit the scope of the present disclosure, but to exemplify the disclosure.

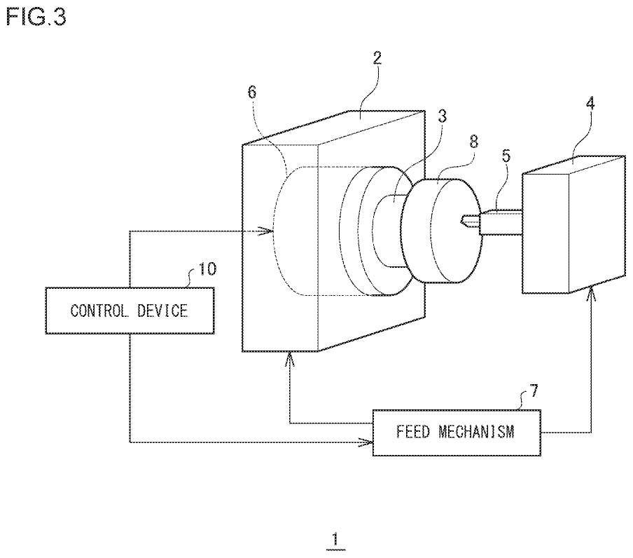

FIG. 3 shows a schematic structure of a machining apparatus 1 according to the embodiment. The machining apparatus 1 is a cutting apparatus that brings a cutting edge of a cutting tool 5 into contact with a workpiece 8 to turn the workpiece 8. The machining apparatus 1 includes a headstock 2 that supports a spindle 3 rotatable and a tool post 4 that supports the cutting tool 5 movable. A rotation mechanism 6 is provided inside the headstock 2 and rotates the spindle 3 to which the workpiece 8 is attached. A feed mechanism 7 moves the cutting tool 5 relative to the workpiece 8.

The rotation mechanism 6 and the feed mechanism 7 serve as a motion mechanism that moves the cutting tool 5 relative to the workpiece 8. The motion mechanism may include a mechanism that rotates the orientation of the cutting tool 5 about a cutting motion direction. Note that the rotation mechanism for rotating the tool orientation is provided as a part of the feed mechanism 7, and may be used to change the orientation of the cutting tool 5 relative to the workpiece 8.

A control device 10 includes a rotation controller that controls the rotation of the spindle 3 made by the rotation mechanism 6, and a movement controller that causes, while the spindle 3 is rotating, the feed mechanism 7 to bring the cutting tool 5 into contact with the workpiece 8 to cause the cutting tool 5 to cut the workpiece 8. The machining apparatus 1 may be a numerical control (NC) machine tool. The motion mechanism including the rotation mechanism 6 and the feed mechanism 7 includes a drive part such as a motor for each of the rotation mechanism 6 and the feed mechanism 7, and the rotation controller and the movement controller each regulate power to be supplied to a corresponding drive part to control behavior of a corresponding one of the rotation mechanism 6 and the feed mechanism 7.

Note that, in the machining apparatus 1 according to the embodiment, the workpiece 8 is attached to the spindle 3 and is rotated by the rotation mechanism 6, but another example may be employed where the cutting tool 5 is attached to the spindle 3 and is rotated by the rotation mechanism 6. Further, the feed mechanism 7 only needs to move the cutting tool 5 or change the orientation of the cutting tool 5 relative to the workpiece 8, and to have a mechanism for moving or changing the orientation of at least either the cutting tool 5 or the workpiece 8. The control device 10 controls operation of the motion mechanism including the rotation mechanism 6 and the feed mechanism 7 to perform cutting process on the workpiece 8 to manufacture the Fresnel lens mold.

### First Example

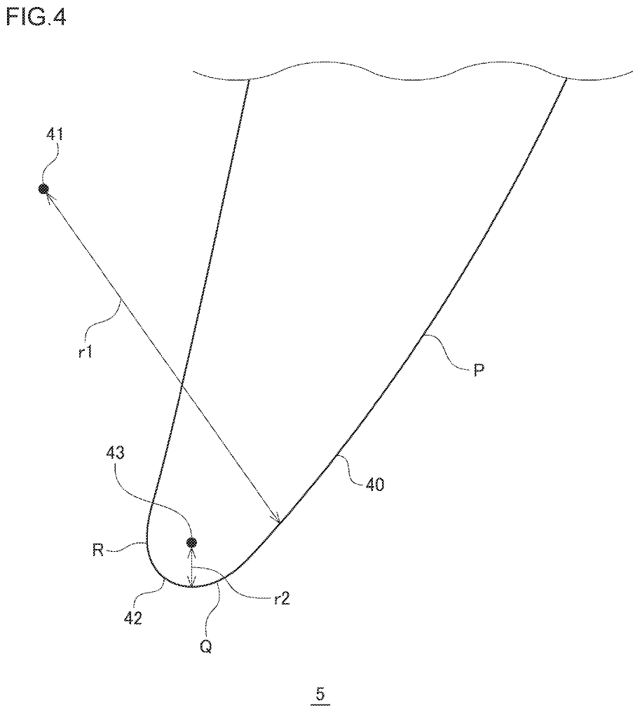

FIG. 4 shows an outline of the cutting edge shape of the cutting tool 5 according to the first example. The cutting tool 5 is preferably a diamond tool suitable for ultra-precision machining, and more preferably a single crystal diamond tool. The cutting tool 5 according to the first example has a first cutting edge 40 having an arc shape with a radius r1 and a second cutting edge 42 continuous to the first cutting edge 40 and having an arc shape with a radius r2. In FIG. 4, a point Q is a boundary between the first cutting edge 40 and the second cutting edge 42. A ridgeline extending between points P and Q serve as the first cutting edge 40 having an arc shape with the radius r1 centered about a first center 41, and a ridgeline extending between points R and Q serves as the second cutting edge 42 having an arc shape with the radius r2 centered about a second center 43.

In the cutting tool 5, the first center 41 serving as the arc center of the first cutting edge 40 is set outside the cutting tool 5, and the second center 43 serving as the arc center of the second cutting edge 42 is set inside the cutting tool 5. As shown, the second cutting edge 42 according to the first example serves as a nose cutting edge located at the tip of the cutting tool 5, so that the radius r2 is a nose radius and is smaller than the radius r1. According to the first example, the machining apparatus 1 performs cutting process on the workpiece 8 with the cutting tool 5 shown in FIG. 4.

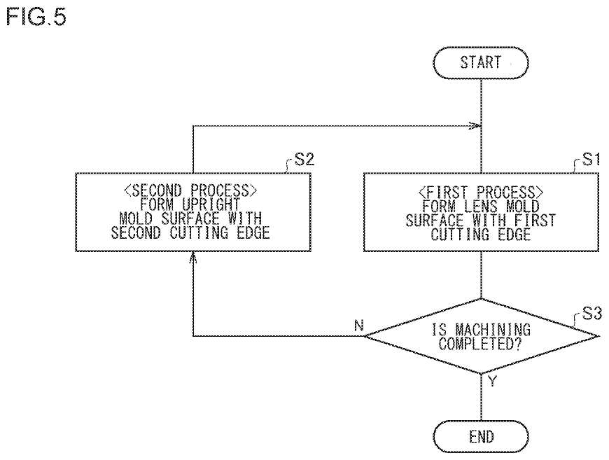

FIG. 5 shows a procedure of forming the Fresnel lens mold. The control device 10 drives the rotation mechanism 6 to rotate the workpiece 8 attached to the spindle 3. The control device 10 controls the feed mechanism 7 to move the cutting tool 5 relative to the workpiece 8. The control device 10 alternately and repeatedly performs a first process (S1) of forming, with the first cutting edge 40, a lens mold surface serving as a mold of a lens surface of the Fresnel lens, and a second process (S2) of forming, with the second cutting edge 42, an upright mold surface serving as a mold of an upright surface of the Fresnel lens. The first process (S1) and the second process (S2) are repeatedly performed until all the lens mold surfaces are formed (N in S3), and when all the lens mold surfaces are formed (Y in S3), the manufacture of the Fresnel lens mold is completed, and the cutting process is brought to an end.

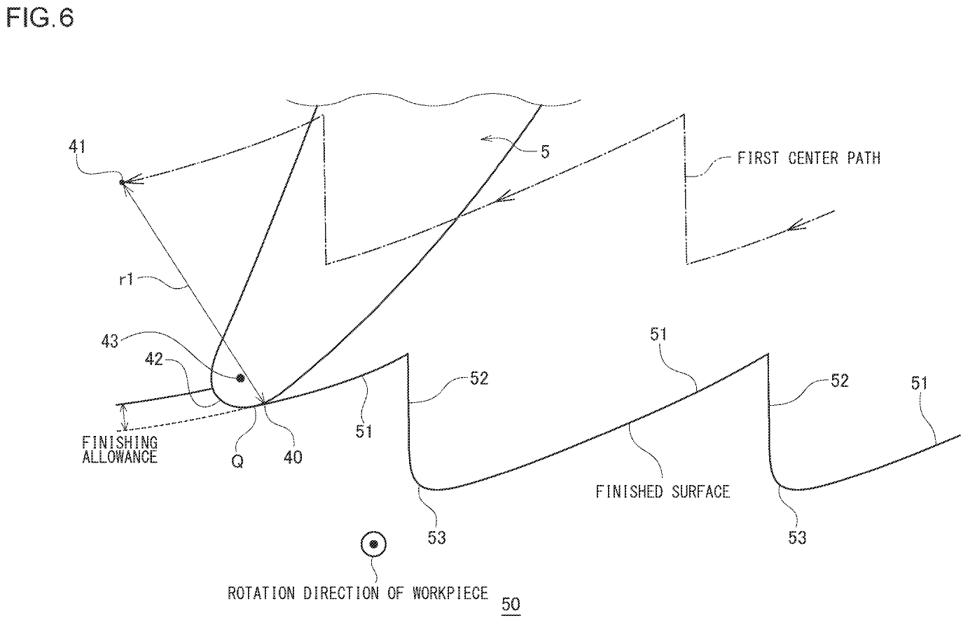

FIG. 6 is a diagram for describing finishing process on the Fresnel lens mold according to the first example. FIG. 6 shows a state of the first process where the lens mold surface 51 is finished by the first cutting edge 40. A Fresnel lens mold 50 has a surface shape having the lens mold surface 51 serving as a mold of the lens surface 21 of the Fresnel lens 20 and an upright mold surface 52 serving as a mold of the upright surface 22 of the Fresnel lens 20 concentrically and alternately arranged.

In the first process, the control device 10 feeds the cutting tool 5 on a path where the first center 41 of the first cutting edge 40 is separated from a target cross-sectional shape of the lens mold surface 51 by r1 to finish the lens mold surface 51. At the end of the first process, a corner 53 having a shape that results from transferring the shape of the second cutting edge 42 is formed. In the second process, the control device 10 feeds the cutting tool 5 on a path where the second center 43 of the second cutting edge 42 is separated from a target cross-sectional shape of the upright mold surface 52 by r2 to finish the upright mold surface 52. In the first process and the subsequent second process, it is preferable that the control device 10 do not change the orientation of the cutting tool 5, but the control device 10 may rotate, when switching from the first process to the second process, the orientation of the cutting tool 5 about the second center 43. A long dashed short dashed line shown in FIG. 6 represents a path on which the first center 41 moves in the first process and the second process. Note that the inclination of the lens mold surface 51 varies between the first process and another first process; therefore, the control device 10 needs to change the orientation of the cutting tool 5. When the feed mechanism 7 includes the rotation mechanism for rotating the tool orientation as described above, the control device 10 controls the feed mechanism 7 to change the tool orientation for each first process of forming the lens mold surface 51.

A third cutting edge (a cutting edge extending in a direction opposite to a direction from the point R to the point Q shown in FIG. 4) opposite from the first cutting edge 40 across the second cutting edge 42 is not involved in the creation of the finished surface in either the first process or the second process. The third cutting edge may linearly extend to smoothly connect to the second cutting edge 42, and may be inclined in a direction separating from the target upright mold surface 52. Note that the path of the feed motion may be a path in the opposite direction.

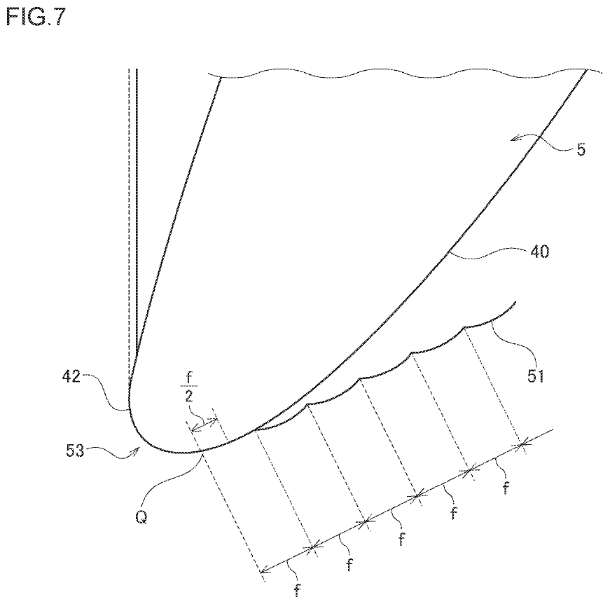

FIG. 7 shows a state of the cutting edge of the cutting tool 5 located at the corner 53. It is desirable that the inclination of the point Q where the second cutting edge 42 and the first cutting edge 40 are connected be approximately equal to the inclination of a point where the inclination of the lens mold surface 51 becomes the smallest (closest to the horizontal). More specifically, it is desirable that, with the corner 53 formed by the second cutting edge 42, a tangent to the first cutting edge 40 at a position separated, by f/2, from the point Q to a side where the radius becomes larger along the lens mold surface 51 be equal to or closest to the smallest inclination of the target lens mold surface 51.

Since the orientation of the cutting tool 5 (rotation orientation about the cutting motion direction) is constant in each first process, it is desirable that the control device 10 determine, in the first process, the rotation orientation of the cutting tool 5 about the cutting motion direction such that the tangent to the first cutting edge 40 at a position separated, by f/2, from the point Q to a side where the radius becomes larger along the lens mold surface 51 when the corner 53 is formed by the second cutting edge 42 is equal to or closest to the smallest inclination of the target lens mold surface 51. When the orientation of the cutting tool 5 is determined as described above, all of the lens mold surfaces 51 can be finished by the first cutting edge 40 with high efficiency. The orientation of the cutting tool 5 may be determined on the basis of the smallest inclination angle of each lens mold surface 51.

According to the first example, with the radius r1 of the first cutting edge 40 set to 1 mm, even when the feed amount f per revolution is set to 14 μm, the finished surface roughness Rth equivalent of a mirror surface level (about 0.0245 μm) can be achieved. Forming the lens mold surface 51 with the first cutting edge 40 larger in diameter than the nose cutting edge as described above allows an increase in the feed amount f, and thus allows high machining efficiency.

Note that the structure where the cutting tool 5 has the first cutting edge 40 having an arch shape with the radius r1 and the second cutting edge 42 continuous to the first cutting edge 40 and having an arc shape with the radius r2 has been described, but the second cutting edge 42 may be a corner having an acute angle (acute-angled portion) with a radius of 0. Such a structure prevents an arc from being left at the corner 53 and thus can eliminate the transferred portion that causes an optical loss. Note that the second cutting edge 42 formed of an acute-angled portion has a possibility of being chipped during machining; therefore, it is desirable that rounding or chamfering process called honing process be performed when the workpiece 8 is high in hardness, and the tool cutting edge is low in toughness.

### Second Example

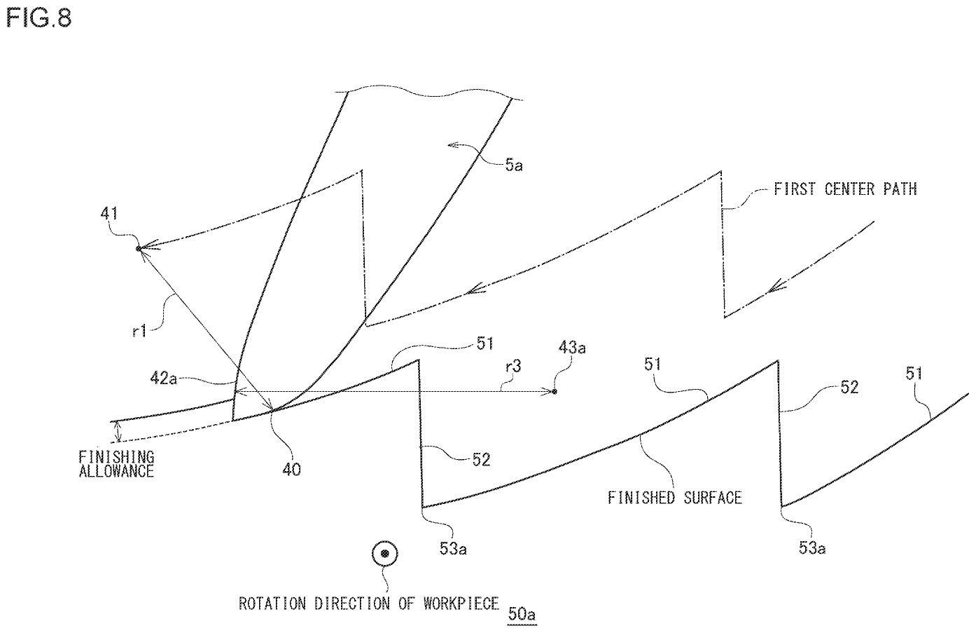

FIG. 8 is a diagram for describing finishing process on the Fresnel lens mold according to the second example. According to the second example, the control device 10 uses a cutting tool 5a different from the cutting tool according to the first example. Also according to the second example, the control device 10 manufactures a Fresnel lens mold in accordance with the forming procedure shown in FIG. 5.

The cutting tool 5a according to the second example has a first cutting edge 40 having an arc shape with a radius r1 and a second cutting edge 42a continuous to the first cutting edge 40 and having an arc shape with a radius r3. In the cutting tool 5a, a first center 41 serving as the arc center of the first cutting edge 40 and a second center 43a serving as the arc center of the second cutting edge 42a are both set outside the cutting tool 5a, and their respective radii r1, r3 are large. Note that it is preferable that r3≥r1 be satisfied. The cutting tool 5a has no nose cutting edge, and the first cutting edge 40 and the second cutting edge 42a are connected at a cutting edge ridgeline. Therefore, the cutting edge ridgeline forms an acute-angled portion.

With reference to FIG. 5, the control device 10 alternately and repeatedly performs a first process (S1) of forming, with the first cutting edge 40, a lens mold surface 51 serving as a mold of a lens surface of the Fresnel lens, and a second process (S2) of forming, with the second cutting edge 42a, an upright mold surface 52 serving as a mold of an upright surface of the Fresnel lens. The first process (S1) and the second process (S2) are repeatedly performed until all the lens mold surfaces 51 are formed (N in S3), and when all the lens mold surfaces 51 are formed (Y in S3), the manufacture of the Fresnel lens mold is completed, and the cutting process is brought to an end.

Compared to the finished surface shown in FIG. 6, since the cutting tool 5a has no nose cutting edge, no arc is left at a corner 53a, and a transferred portion that causes an optical loss can be eliminated. When the cutting edge ridgeline is an acute-angled portion, it is desirable that rounding or chamfering process called honing process be performed as described above.

The upright mold surface 52 of the mold for use in molding is often formed with a slight inclination as draft (in FIGS. 6 and 8, the inclination of the upright mold surface 52 to the left becomes gradually larger at the top of the upright mold surface 52). The finished surface roughness Rth of the upright mold surface 52 is not optically important, but it is desirable that the finished surface roughness Rth be as small as possible for easy removal. Therefore, according to the second example, in order to reduce the finished surface roughness Rth of the upright mold surface 52 and increase the feed amount f when finishing the upright mold surface 52, the cutting tool 5a having the second cutting edge 42a continuous to the first cutting edge 40 and having an arc shape with the large radius r3 is used. The use of the cutting tool 5a allows an increase in the tool feed amount f for the lens mold surface 51 and the upright mold surface 52, and thus allows high machining efficiency.

Note that, in order to form a general Fresnel lens-shaped mold with the cutting tool 5a shown in the second example, it is necessary to change the tool orientation between the first process and the second process. That is, it is necessary to rotate the tool about a tool tip point (a point of intersection, adjacent to the tool tip, of the arc of the first cutting edge 40 and the arc of the second cutting edge 42a). This is because, in a general Fresnel lens shape, the inclination of each upright mold surface 52 is the same, whereas the inclination of each lens mold surface 51 gradually varies in a manner that depends on a radial position.

The present disclosure has been described on the basis of the embodiment. It is to be understood by those skilled in the art that the embodiment is illustrative and that various modifications are possible for a combination of components or processes, and that such modifications are also within the scope of the present disclosure.

According to the embodiment, the method for manufacturing a Fresnel lens mold having the lens surface and the upright surface concentrically and alternately arranged in which the machining apparatus 1 serves as a cutting apparatus that performs turning process on the workpiece 8 has been described. According to a modification, the machining apparatus 1 is a cutting apparatus that performs milling process on the workpiece 8, and may manufacture a linear Fresnel lens mold having a lens surface and an upright surface linearly and alternately arrange. When the machining apparatus 1 is a cutting apparatus that performs milling process, the motion mechanism need not include the rotation mechanism 6 that rotates the spindle, but needs to include a feed mechanism that relatively and linearly moves the workpiece 8 or the cutting tool 5 in the cutting motion direction.

An outline of aspects of the present disclosure is as follows.

One aspect of the present disclosure relates to a method for manufacturing a Fresnel lens mold by performing cutting process on a workpiece with a cutting tool, the Fresnel lens mold having a lens surface and an upright surface alternately arranged. The cutting tool thus used has a first cutting edge having an arc shape with a radius r1 and a second cutting edge continuous to the first cutting edge. The method for manufacturing a mold includes a first process of forming, with the first cutting edge, a lens mold surface serving as a mold of a lens surface of a Fresnel lens, and a second process of forming, with the second cutting edge, an upright mold surface serving as a mold of an upright surface of the Fresnel lens, and the first process and the second process are repeatedly performed to manufacture the Fresnel lens mold.

According to this aspect, the use of different cutting edges between the first process and the second process allows an increase in the feed amount in the first process without an increase in the radius of the arc of the corner at the boundary between the lens mold surface and the upright mold surface.

The second cutting edge may be continuous to the first cutting edge and have an arc shape with a radius r2. The second cutting edge is a nose cutting edge located at the tool tip, and the radius r2 of the second cutting edge may be smaller than the radius r1 of the first cutting edge. In this case, the arc center of the first cutting edge may be located outside the cutting tool, and the arc center of the second cutting edge may be located inside the cutting tool. Note that the arc center of the first cutting edge and the arc center of the second cutting edge may be both located outside the cutting tool.

Another aspect of the present disclosure relates to a machining apparatus structured to perform cutting process on a workpiece with a cutting tool to manufacture a Fresnel lens mold having a lens surface and an upright surface alternately arranged. The cutting tool thus used has a first cutting edge having an arc shape with a radius r1 and a second cutting edge continuous to the first cutting edge. The machining apparatus includes a motion mechanism structured to move the cutting tool relative to the workpiece, and a control device structured to control operation of the motion mechanism to repeatedly perform process of forming a lens mold surface serving as a mold of a lens surface of a Fresnel lens with the first cutting edge and process of forming an upright mold surface serving as a mold of an upright surface of the Fresnel lens with the second cutting edge.

According to this aspect, the use of different cutting edges between the first process and the second process allows an increase in the feed amount in the first process without an increase in the radius of the arc of the corner at the boundary between the lens mold surface and the upright mold surface.

Yet another aspect of the present disclosure relates to a cutting tool for use in manufacturing a Fresnel lens mold. The cutting tool includes a first cutting edge having an arc shape with a radius r1, the first cutting edge being structured to finish a lens mold surface serving as a mold of a lens surface of a Fresnel lens, and a second cutting edge continuous to the first cutting edge, the second cutting edge being structured to finish an upright mold surface serving as a mold of an upright surface of the Fresnel lens.

What is claimed is:

1. A method for manufacturing a Fresnel lens mold by performing cutting process on a workpiece with a cutting tool, the Fresnel lens mold having a lens surface and an upright surface alternately arranged, the cutting tool having a first cutting edge having an arc shape with a radius r1 and a second cutting edge continuous to the first cutting edge and having an arc shape with a radius r2 different from the radius r1, the method comprising:
a first process of forming a lens mold surface serving as a mold of a lens surface of a Fresnel lens with the first cutting edge; and
a second process of forming an upright mold surface serving as a mold of an upright surface of the Fresnel lens with the second cutting edge, wherein
the first process and the second process are repeatedly performed to manufacture the Fresnel lens mold.

2. The method for manufacturing a Fresnel lens mold according to claim 1, wherein
the second cutting edge is a nose cutting edge located at a tool tip, and the radius r2 is smaller than the radius r1.

3. The method for manufacturing a Fresnel lens mold according to claim 2, wherein
an arc center of the first cutting edge is located outside the cutting tool, and an arc center of the second cutting edge is located inside the cutting tool.

4. The method for manufacturing a Fresnel lens mold according to claim 1, wherein
an arc center of the first cutting edge and an arc center of the second cutting edge are both located outside the cutting tool.

5. A machining apparatus that performs cutting process on a workpiece with a cutting tool to manufacture a Fresnel lens mold having a lens surface and an upright surface alternately arranged, the cutting tool having a first cutting edge having an arc shape with a radius r1 and a second cutting edge continuous to the first cutting edge and having an arc shape with a radius r2 different from the radius r1, the machining apparatus comprising:
a motion mechanism structured to move the cutting tool relative to the workpiece; and
a control device structured to control operation of the motion mechanism to repeatedly perform process of forming a lens mold surface serving as a mold of a lens surface of a Fresnel lens with the first cutting edge and process of forming an upright mold surface serving as a mold of an upright surface of the Fresnel lens with the second cutting edge.

6. A cutting tool for use in manufacturing a Fresnel lens mold, the cutting tool comprising:
a first cutting edge having an arc shape with a radius r1, the first cutting edge being structured to finish a lens mold surface serving as a mold of a lens surface of a Fresnel lens; and
a second cutting edge continuous to the first cutting edge at a cutting edge ridgeline, the second cutting edge being structured to finish an upright mold surface serving as a mold of an upright surface of the Fresnel lens.

7. The cutting tool according to claim 6, wherein
the cutting edge ridgeline forms an acute-angled portion.

8. The cutting tool according to claim 6, wherein
honing process is performed on the cutting edge ridgeline.

9. The cutting tool according to claim 6, wherein
an arc center of the first cutting edge and an arc center of the second cutting edge are both located outside the cutting tool.
